(19) United States
(12) Patent Application Publication
(10) Pub. No.: US 2026/0227000 A1
(43) Pub. Date: Aug. 6, 2026

(54) WASTEGATE VALVE DEVICE AND TURBOCHARGER

(71) Applicant: MITSUBISHI HEAVY INDUSTRIES ENGINE & TURBOCHARGER, LTD., Sagamihara-shi, Kanagawa (JP)

(72) Inventors: Takuya ARAKAWA, Tokyo (JP); Kohei TSUKAMOTO, Sagamihara-shi (JP); Yukihide NAGAYO, Tokyo (JP)

(73) Assignee: MITSUBISHI HEAVY INDUSTRIES ENGINE & TURBOCHARGER, LTD., Sagamihara-shi, Kanagawa (JP)

(21) Appl. No.: 19/153,270

(22) PCT Filed: Feb. 28, 2023
(86) PCT No.: PCT/JP2023/007333

§ 371 Date: Aug. 1, 2025

(51) Int. Cl. F16K 31/52; F02B 37/18

(52) U.S. Cl. CPC F16K 31/52; F02B 37/186

(57) ABSTRACT

This wastegate valve device comprises: a valve body; a lever shaft which is joined to the valve body at one end side; a lever plate which is provided to the lever shaft at the other end side; a lever pin which protrudes from the lever plate along the plate thickness direction of the lever plate; a rod which includes, at one end side, a plate-shaped joint part that has formed therein an insertion hole for insertion of the lever pin; an actuator which is for causing the rod to reciprocate; and an R-pin which is attached to the lever pin and which is positioned on the opposite side from the lever plate in the plate thickness direction, with the joint part therebetween. The R-pin includes: an insertion part that is inserted into an extending hole which extends in the lever pin along a direction orthogonal to the plate thickness direction, and that extends in a straight line; an engagement part that engages with the outer circumference of the lever pin, and that extends in a wave shape along the direction of extension of the insertion part; a folded-back part that connects one end of the insertion part on one side in the extension direction and one end of the engagement part on one side in the extension direction; and an extending part that extends toward the joint part from the other end of the engagement part on the other side in the extension direction, and that has a tip end which contacts one end surface of the joint part on the opposite side from the lever plate side.

### TECHNICAL FIELD

The present disclosure relates to a wastegate valve device and a turbocharger including the wastegate valve device.

### BACKGROUND ART

In the related art, a turbocharger including a turbine that is rotated by an exhaust gas of an engine and a compressor that compresses air supplied to the engine by using torque of the turbine is known for the purpose of improving an output of the engine (internal combustion engine) or the like. In addition, in some cases, the turbocharger is provided with a wastegate valve device for preventing damage to the engine, a decrease in engine performance, or the like caused by a rise in a pressure (boost pressure) of an intake air channel of the engine to a specified value or higher.

The wastegate valve device is provided at a bypass line in which at least some of the exhaust gas of the engine bypasses the turbine. The wastegate valve device controls the boost pressure described above such that the boost pressure becomes appropriate by causing some of the exhaust gas to flow to the bypass line to regulate the amount of the exhaust gas flowing into the turbine. Such a wastegate valve device performs an opening/closing operation (opening/closing amount adjustment) of a valve body by driving an actuator (for example, an electric actuator) based on the pressure of the intake air channel of the engine.

The wastegate valve device includes a plurality of link components that are linked to each other so that driving of the actuator can be transmitted to the valve body. Specifically, the plurality of link components include a lever shaft that has one end side connected to the valve body, a lever plate that is provided on the other end side of the lever shaft, a lever pin that protrudes from the lever plate along a plate thickness direction of the lever plate, and a rod that includes a plate-shaped joint part, in which an insertion hole through which the lever pin is inserted is formed, on one end side thereof, and that reciprocates due to the actuator.

Meanwhile, when pulsation of the exhaust gas from an engine side, vibration from an actuator side, or the like occurs, any one of the plurality of link components such as a rod vibrates. When any one of the plurality of link components vibrates, there is a concern that a chattering noise (noise generated by the plurality of link components coming into contact with each other) is generated from the wastegate valve device, and a decrease in quietness of a wastegate valve is caused. In addition, there is a concern that wear occurs due to the plurality of link components coming into contact with each other.

For such a concern, for example, PTL 1 discloses that a biasing member for biasing the lever pin toward the joint part of the rod or a center side of the insertion hole is provided inside the insertion hole in order to suppress contact between the joint part of the rod and the lever pin.

### CITATION LIST

### Patent Literature

[PTL 1] Japanese Unexamined Patent Application Publication No. 2018-071550

### SUMMARY OF INVENTION

### Technical Problem

However, in the technique described in PTL 1, no consideration is given to noise or wear generated by collision between the joint part of the rod and the lever plate.

The present disclosure has been made in view of the problems described above, and an object of the present disclosure is to provide a wastegate valve device that can suppress generation of noise or wear caused by collision between a joint part of a rod and a lever plate.

### Solution to Problem

According to an aspect of the present disclosure, in order to achieve the object, there is provided a wastegate valve device including a valve body, a lever shaft that has one end side connected to the valve body, a lever plate that is provided on the other end side of the lever shaft, a lever pin that protrudes from the lever plate along a plate thickness direction of the lever plate, a rod that includes a plate-shaped joint part, in which an insertion hole through which the lever pin is inserted is formed, on one end side thereof, an actuator for causing the rod to reciprocate, and an R-pin that is attached to the lever pin and that is positioned on an opposite side to the lever plate with the joint part interposed therebetween in the plate thickness direction, in which the R-pin includes an insertion part in which the lever pin is inserted through an extending hole extending along a direction orthogonal to the plate thickness direction and that extends in a linear shape, a locking part that is locked to an outer periphery of the lever pin and that extends in a corrugated shape along an extending direction of the insertion part, a folded-back part that connects one end of the insertion part on one side in the extending direction and one end of the locking part on the one side in the extending direction, and an extending part that extends toward the joint part with the other end of the locking part on the other side in the extending direction as a base point and that has a tip which comes into contact with one end surface of the joint part on an opposite side to a lever plate side.

### Advantageous Effects of Invention

With the wastegate valve device of the present disclosure, generation of noise or wear caused by collision between the joint part of the rod and the lever plate can be suppressed.

### BRIEF DESCRIPTION OF DRAWINGS

FIG. 1 is a perspective view schematically showing a configuration of a turbocharger including a wastegate valve device according to some embodiments.

FIG. 2 is a view schematically showing a configuration of a wastegate valve device according to a first embodiment.

FIG. 3 is a view schematically showing a configuration of an R-pin according to the first embodiment.

FIG. 4 is a view showing a state where the R-pin shown in FIG. 3 is attached to a lever pin.

FIG. 5 is a view showing a state where the R-pin shown in FIG. 3 is attached to the lever pin.

FIG. 6 is a view schematically showing a configuration of an R-pin according to some embodiments.

FIG. 7 is an enlarged view of a tip of an extending part according to some embodiments.

FIG. 8 is a view schematically showing a configuration of an R-pin according to a second embodiment.

FIG. 9 is a view showing a state where the R-pin shown in FIG. 8 is attached to the lever pin.

FIG. 10 is a view showing a state where an R-pin according to a first modification example of the second embodiment is attached to the lever pin.

FIG. 11 is a view showing a state where an R-pin according to a second modification example of the second embodiment is attached to the lever pin.

FIG. 12 is a view showing a state where an R-pin according to a third embodiment is attached to the lever pin.

FIG. 13 is a view showing a state where an R-pin according to a fourth embodiment is attached to the lever pin.

### DESCRIPTION OF EMBODIMENTS

Hereinafter, a wastegate valve device and a turbocharger according to embodiments of the present disclosure will be described based on the drawings. Such embodiments show one aspect of the present disclosure, are not limited to this disclosure, and can be freely changed within the scope of the technical idea of the present disclosure.

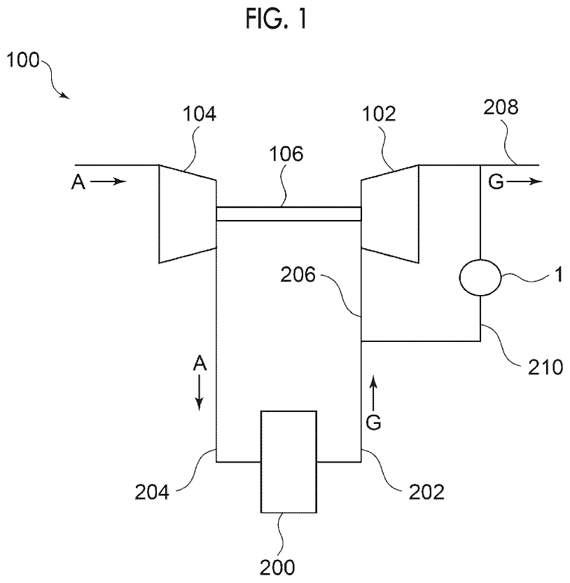

FIG. 1 is a view schematically showing a configuration of a turbocharger 100 including a wastegate valve device 1 according to some embodiments. As shown in FIG. 1, the turbocharger 100 includes a turbine wheel 102, a compressor wheel 104, a rotating shaft 106 that connects the turbine wheel 102 and the compressor wheel 104, and the wastegate valve device 1.

The turbine wheel 102 is provided at an exhaust gas line 202 through which an exhaust gas G exhausted from an engine 200 flows. The compressor wheel 104 is provided at an intake line 204 through which combustion air A supplied to the engine 200 flows. The rotating shaft 106 has a longitudinal direction, one end portion thereof in the longitudinal direction is mechanically connected to the turbine wheel 102, and the other end portion thereof in the longitudinal direction is mechanically connected to the compressor wheel 104. For this reason, power of the turbine wheel 102 that is rotationally driven by the exhaust gas G is transmitted to the compressor wheel 104 via the rotating shaft 106, and the combustion air A flowing through the intake line 204 is compressed.

The exhaust gas line 202 includes a bypass line 210 for sending some of the exhaust gas G from an upstream side to a downstream side of the turbine wheel 102 without passing through the turbine wheel 102. In a form shown in FIG. 1, the exhaust gas line 202 includes an upstream exhaust gas line 206 that connects the engine 200 and the turbine wheel 102, a downstream exhaust gas line 208 through which the exhaust gas G that has passed through the turbine wheel 102 flows, and the bypass line 210 that connects the upstream exhaust gas line 206 and the downstream exhaust gas line 208.

The wastegate valve device 1 is provided at the bypass line 210 and is configured to open and close the bypass line 210. The wastegate valve device 1 can reduce the amount and thermal energy of the exhaust gas G sent to the turbine wheel 102 by diverting some of the exhaust gas G flowing in the upstream exhaust gas line 206 toward the turbine wheel 102 to the bypass line 210. That is, the wastegate valve device 1 can reduce a boost pressure of the combustion air A. Hereinafter, the wastegate valve device 1 will be specifically described.

### First Embodiment

### (Configuration)

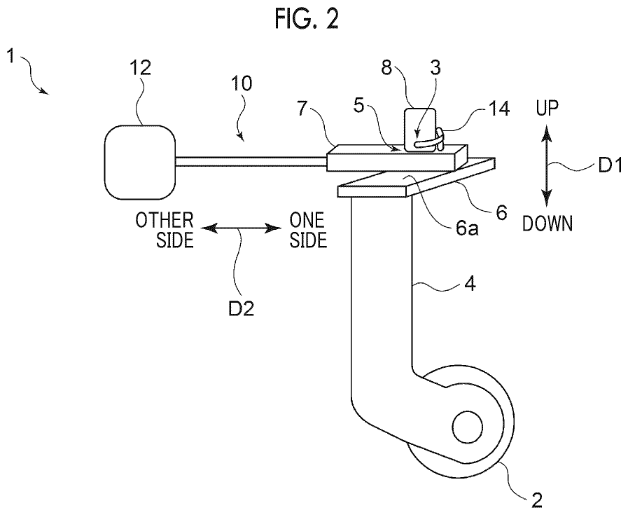

FIG. 2 is a view schematically showing a configuration of the wastegate valve device 1 according to a first embodiment. As shown in FIG. 2, the wastegate valve device 1 includes a valve body 2, a lever shaft 4, a lever plate 6, a lever pin 8, a rod 10, an actuator 12, and an R-pin 14.

The valve body 2 is disposed in the bypass line 210. The lever shaft 4 has a rod shape, and one end side (a lower side in the plane of FIG. 2) thereof is connected to the valve body 2.

The lever plate 6 has a flat plate shape and is provided on the other end side (an upper side in the plane of FIG. 2) of the lever shaft 4. Hereinafter, one side, which is a valve body 2 side in a plate thickness direction of the lever plate 6 (hereinafter, referred to as a plate thickness direction D1) will be referred to as a lower side, and the other side, which is an opposite side to the valve body 2 side in the plate thickness direction D1, will be referred to as an upper side.

The lever pin 8 has a columnar shape and protrudes upward from an upper surface 6a of the lever plate 6 along the plate thickness direction D1. The lever pin 8 may be configured integrally with the lever plate 6 or may be fixed to the lever plate 6 by a fastening part such as a bolt. An extending hole 3 extending along a direction (horizontal direction) orthogonal to the plate thickness direction D1 is formed in the lever pin 8. In a form shown in FIG. 2, the extending hole 3 extends along a direction (intersecting direction D3) intersecting a direction (extending direction D2) in which the rod 10 extends in the horizontal direction.

The rod 10 includes a plate-shaped joint part 7 in which an insertion hole 5 through which the lever pin 8 is inserted is formed, on one end side. In a form shown in FIG. 2, the rod 10 extends in a linear shape from the actuator 12 toward the lever pin 8 and connects the lever pin 8 and the actuator 12. The rod 10 is not limited to a shape extending in a linear shape and may be curved or bent. Hereinafter, a direction in which the rod 10 extends from the actuator 12 toward the lever pin 8 will be referred to as one side in the extending direction D2, and a direction opposite to the one side in the extending direction D2 will be referred to as the other side in the extending direction D2.

The actuator 12 reciprocates the rod 10 along the extending direction D2. The actuator 12 reciprocates the rod 10 along the extending direction D2, for example, according to the pressure of the combustion air A supplied to the engine 200. Such an actuator 12 may be an electric actuator using an electric motor as a driving source or may be a positive pressure type actuator.

The wastegate valve device 1 including the configuration described above transmits reciprocation of the rod 10 in order of the lever pin 8, the lever plate 6, the lever shaft 4, and the valve body 2. The wastegate valve device 1 is configured to open and close the valve body 2 in conjunction with the reciprocation of the rod 10.

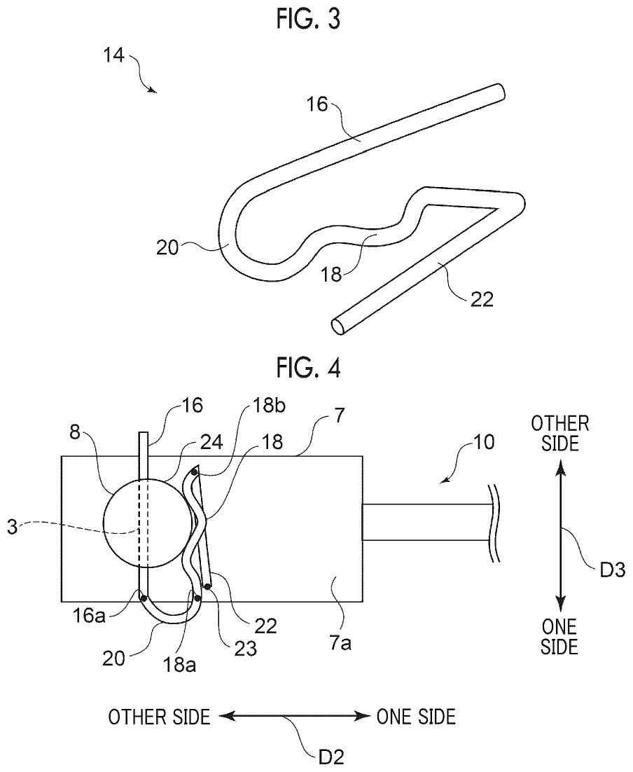

The R-pin 14 is attached to the lever pin 8. The R-pin 14 is positioned on an opposite side to the lever plate 6 with the joint part 7 of the rod 10 interposed therebetween in the plate thickness direction D1. That is, the R-pin 14 is positioned above the joint part 7 of the rod 10. Such an R-pin 14 prevents the rod 10 from coming out of the lever pin 8 by interfering with the joint part 7. A specific configuration of the R-pin 14 will be described with reference to FIG. 3.

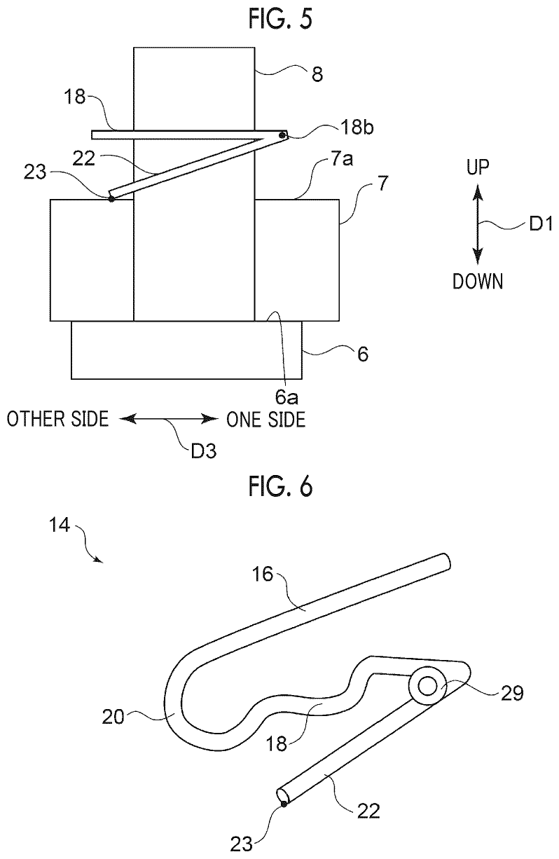

FIG. 3 is a view schematically showing a configuration of the R-pin 14 according to the first embodiment. FIG. 4 is a view showing a state where the R-pin 14 shown in FIG. 3 is attached to the lever pin 8, and the lever pin 8 is viewed from above in the plate thickness direction D1. FIG. 5 is a view showing a state where the R-pin 14 shown in FIG. 3 is attached to the lever pin 8, and the R-pin 14 is viewed from the one side in the extending direction D2.

As shown in FIG. 3, the R-pin 14 includes an insertion part 16, a locking part 18, a folded-back part 20, and an extending part 22. The R-pin 14 is made of, for example, a flexible metal such as stainless steel.

The insertion part 16 extends in a linear shape. As shown in FIG. 4, the insertion part 16 is inserted through the extending hole 3 formed in the lever pin 8. The insertion part 16 penetrates the lever pin 8. The locking part 18 is locked to an outer periphery 24 of the lever pin 8. The locking part 18 extends in a corrugated shape along an extending direction of the insertion part 16 (hereinafter, referred to as the intersecting direction D3). The locking part 18 has an arc in the middle and is gently bent a plurality of times. The locking part 18 is in contact with a portion of the outer periphery 24 of the lever pin 8 on the one side in the extending direction D2. The folded-back part 20 connects one end 16a of the insertion part 16 on one side in the intersecting direction D3 and one end 18a of the locking part 18 on the one side in the intersecting direction D3. For this reason, the R-pin 14 is fixed to the lever pin 8 as the insertion part 16 and the locking part 18 sandwich the lever pin 8 with a restoring force of the R-pin 14.

The extending part 22 extends toward the joint part 7 with the other end 18b of the locking part 18 on the other side in the intersecting direction D3 as a base point. As shown in FIG. 5, a tip 23 of the extending part 22 comes into contact with an upper surface 7a which is one end surface on an opposite side to a lever plate 6 side of the joint part 7.

In the first embodiment, as shown in FIG. 4, each of the locking part 18 and the extending part 22 is positioned on an opposite side to the one end side of the rod 10 with respect to the insertion part 16. Specifically, each of the locking part 18 and the extending part 22 is positioned on the one side (actuator 12 side) of the insertion part 16 in the extending direction D2.

### (Operations and Effects)

Operations and effects of the wastegate valve device 1 according to the first embodiment will be described. According to the first embodiment, the R-pin 14 can have a pressing function of pressing the joint part 7 of the rod 10 against the lever plate 6 by including the extending part 22 in addition to a retaining function from the related art. The pressing function eliminates a gap (clearance) between the joint part 7 of the rod 10 and the lever plate 6 and suppresses shaking of the joint part 7 of the rod 10 in the plate thickness direction D1. For this reason, generation of noise or wear caused by collision between the joint part 7 of the rod 10 and the lever plate 6 can be suppressed. In addition, since it is only necessary to include the extending part 22 in the R-pin provided in the wastegate valve device from the related art instead of adding a member such as a leaf spring to the wastegate valve device 1, an increase in costs can be suppressed. Further, as the R-pin 14 has a pressing function, contact between the lever pin 8 inserted through the insertion hole 5 of the joint part 7 and an inner peripheral surface of the insertion hole 5 can be suppressed, and generation of noise or wear caused by collision between the joint part 7 and the lever pin 8 can also be suppressed.

When the joint part 7 vibrates along the plate thickness direction D1, there is a case where a gap formed between the joint part 7 and the lever plate 6 increases from the lever pin 8 toward the one side (actuator side) in the extending direction D2. According to the first embodiment, the tip 23 of the extending part 22 presses the joint part 7 of the rod 10 against the lever plate 6 from the one side in the extending direction D2 with respect to the lever pin 8. Therefore, shaking of the joint part 7 of the rod 10 in the plate thickness direction D1 can be further suppressed. In the first embodiment, the tip 23 of the extending part 22 is positioned on the one side in the extending direction D2 with respect to the lever pin 8. However, the present disclosure is not limited to this form. Although not shown, in some embodiments, the extending part 22 is positioned on the other side in the extending direction D2 with respect to the insertion part 16. In some embodiments, the extending part 22 is positioned on the one side or the other side in the intersecting direction D3 (a width direction of the lever plate 6) with respect to the lever pin 8. In this case, the extending hole 3 of the lever pin 8 extends along the extending direction D2.

FIG. 6 is a view schematically showing a configuration of the R-pin 14 according to some embodiments. In a form shown in FIG. 6, the extending part 22 includes a twisted portion 29 of which at least a part is twisted in an annular shape. The twisted portion 29 is positioned on an opposite side to a tip 23 side of the extending part 22 in a direction in which the extending part 22 extends. With such a configuration, the R-pin 14 increases a load that presses the joint part 7 of the rod 10 against the lever plate 6, and the shaking of the joint part 7 of the rod 10 in the plate thickness direction D1 can be further suppressed.

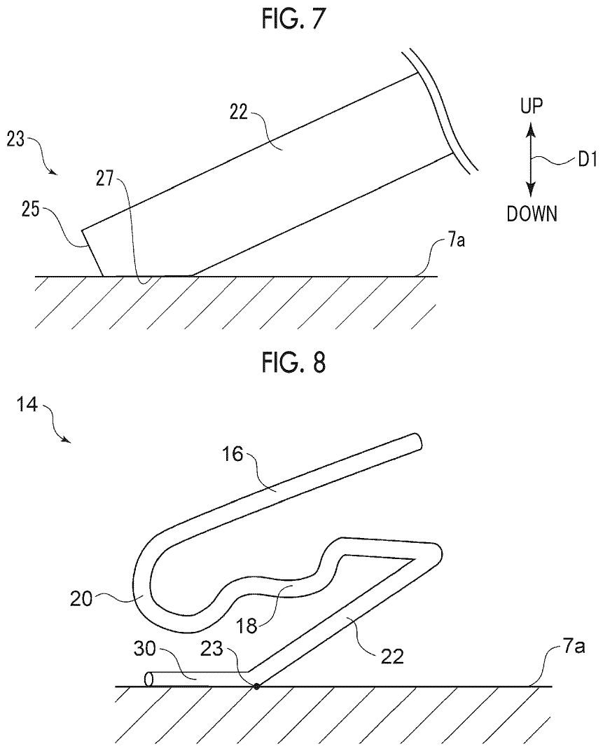

FIG. 7 is an enlarged view of the tip 23 of the extending part 22 according to some embodiments. In a form shown in FIG. 7, the extending part 22 includes a contact surface 27 that is formed by cutting out a lower side of a tip surface 25 positioned farthest from the other end 18b of the locking part 18. With such a configuration, the area of contact between the tip 23 of the extending part 22 and the upper surface 7a of the joint part 7 can be increased.

### Second Embodiment

The wastegate valve device 1 according to a second embodiment of the present disclosure will be described. The second embodiment is different from the first embodiment in that the R-pin 14 further includes a line contact portion 30. In the second embodiment, the same components as those in the first embodiment are denoted by the same reference signs, and detailed description thereof will be omitted.

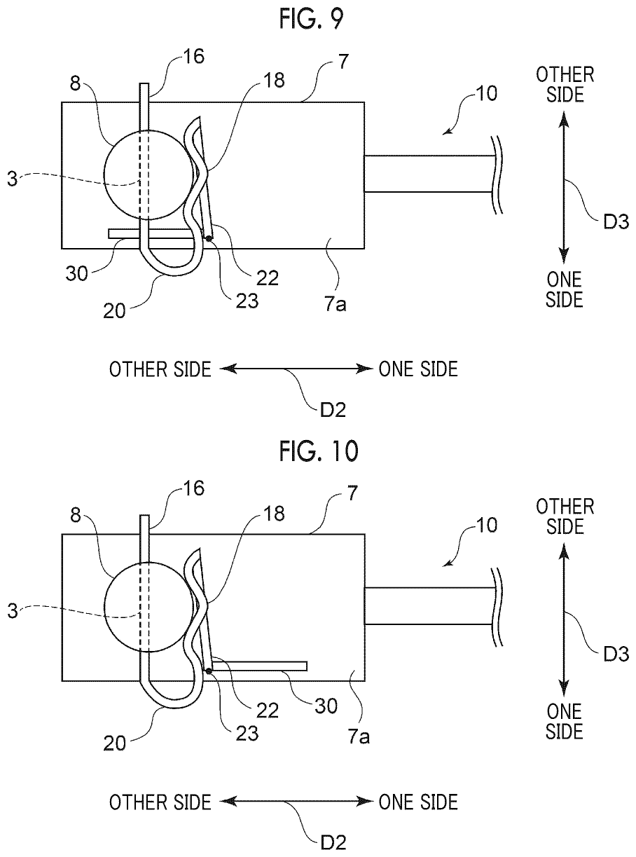

FIG. 8 is a view schematically showing a configuration of the R-pin 14 according to the second embodiment. FIG. 9 is a view showing a state where the R-pin 14 shown in FIG. 8 is attached to the lever pin 8. As shown in FIG. 8, the R-pin 14 further includes the line contact portion 30 that extends in a linear shape from the tip 23 of the extending part 22. The line contact portion 30 is in contact with the upper surface 7a of the joint part 7. In the second embodiment, as shown in FIG. 9, the line contact portion 30 extends along the other side in the extending direction D2 from the tip 23 of the extending part 22.

According to the second embodiment, a load with which the R-pin 14 presses the joint part 7 of the rod 10 against the lever plate 6 acts widely on the upper surface 7a of the joint part 7, and thus the shaking of the joint part 7 of the rod 10 in the plate thickness direction D1 can be further suppressed.

However, in the first embodiment, since only the tip 23 of the extending part 22 is in contact with the upper surface 7a of the joint part 7, a contact area is small, and there is a concern that at least one of the tip 23 of the extending part 22 and the upper surface 7a of the joint part 7 is worn due to a load of the R-pin 14. On the other hand, according to the second embodiment, since the contact area can be increased, wear of either the tip 23 of the extending part 22 or the upper surface 7a of the joint part 7 caused by the load of the R-pin 14 can be suppressed.

In the second embodiment, the line contact portion 30 extends from the tip 23 of the extending part 22 along the other side in the extending direction D2 such that shaking in a case where the lever plate 6 or the joint part 7 vibrates significantly in the vicinity of the lever pin 8 can be effectively suppressed. However, the present disclosure is not limited to this form. A direction in which the line contact portion 30 is extended may be determined in accordance with the vibration of the lever plate 6 or the joint part 7.

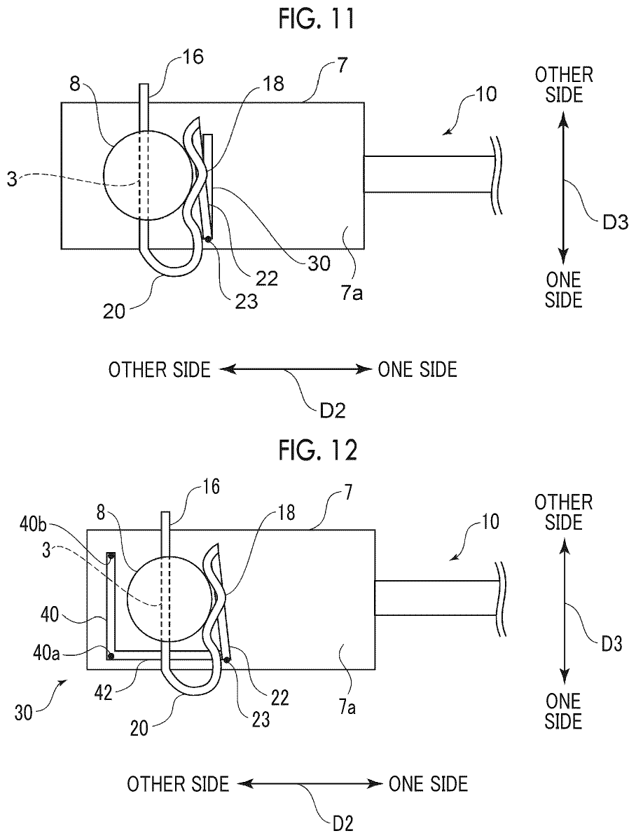

FIG. 10 is a view showing a state where the R-pin 14 according to a first modification example of the second embodiment is attached to the lever pin 8. FIG. 11 is a view showing a state where the R-pin 14 according to a second modification example of the second embodiment is attached to the lever pin 8. In a form shown in FIG. 10, the line contact portion 30 extends along the one side in the extending direction D2 from the tip 23 of the extending part 22. With the configuration of FIG. 10, the R-pin 14 presses the joint part 7 against the lever plate 6 for a long time in the extending direction D2. For this reason, for example, it is advantageous in a case where the entire lever plate 6 is displaced and vibrated in parallel with the same displacement in the same phase. In a form shown in FIG. 11, the line contact portion 30 extends from the tip 23 of the extending part 22 along the other side in the intersecting direction D3. With the configuration shown in FIG. 11, the R-pin 14 can press the joint part 7 against the lever plate 6 in a balanced manner in the intersecting direction D3. In addition, a load with which the R-pin 14 presses the joint part 7 against the lever plate 6 can be increased.

### Third Embodiment

The wastegate valve device 1 according to a third embodiment of the present disclosure will be described. The third embodiment is different from the second embodiment in that the line contact portion 30 further includes each of a facing portion 40 and an extending connecting portion 42. In the third embodiment, the same components as those in the second embodiment are denoted by the same reference signs, and detailed description thereof will be omitted.

FIG. 12 is a view showing a state where the R-pin 14 according to the third embodiment is attached to the lever pin 8. In the third embodiment, as shown in FIG. 12, the line contact portion 30 includes the facing portion 40 that is positioned on an opposite side to the extending part 22 in the extending direction D2 with the lever pin 8 interposed therebetween and the extending connecting portion 42 that connects the facing portion 40 and the extending part 22.

In a form shown in FIG. 12, the facing portion 40 extends long along the intersecting direction D3 while being in contact with the upper surface 7a of the joint part 7. One end 40a of the facing portion 40 on the one side in the intersecting direction D3 is positioned on the one side in the intersecting direction D3 with respect to the lever pin 8. The other end 40b of the facing portion 40 on the other side in the intersecting direction D3 is positioned on the other side in the intersecting direction D3 with respect to the lever pin 8. The extending connecting portion 42 connects the one end 40a of the facing portion 40 and the tip 23 of the extending part 22. The extending connecting portion 42 is in contact with the upper surface 7a of the joint part 7.

According to the third embodiment, the R-pin 14 presses the joint part 7 of the rod 10 against the lever plate 6 from both sides of the lever pin 8 about the lever pin 8 in the extending direction D2. Therefore, an effect of suppressing the shaking of the joint part 7 of the rod 10 in the plate thickness direction D1 can be increased.

### Fourth Embodiment

The wastegate valve device 1 according to a fourth embodiment of the present disclosure will be described. The fourth embodiment is different from the first embodiment in that the R-pin 14 further includes each of a second insertion part 50, a second locking part 52, a second folded-back part 54, a second extending part 56, and a connecting portion 58. In the fourth embodiment, the same components as those in the first embodiment are denoted by the same reference signs, and detailed description thereof will be omitted.

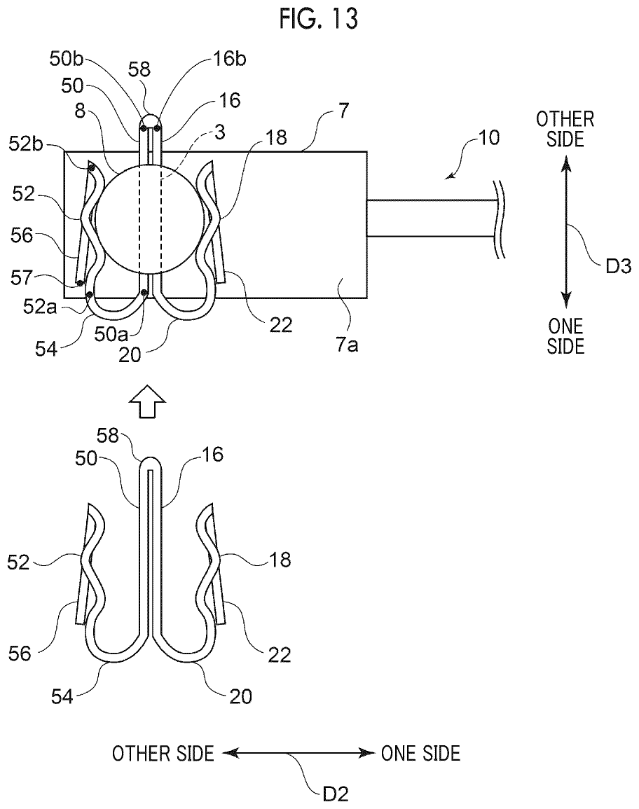

FIG. 13 is a view showing a state where the R-pin 14 according to the fourth embodiment is attached to the lever pin 8. In the fourth embodiment, as shown in FIG. 13, the R-pin 14 further includes the second insertion part 50, the second locking part 52, the second folded-back part 54, the second extending part 56, and the connecting portion 58.

The second insertion part 50 extends in a linear shape. As shown in FIG. 13, the second insertion part 50 is inserted through the extending hole 3 formed in the lever pin 8. The second insertion part 50 is inserted into the common extending hole 3 together with the insertion part 16 and penetrates the lever pin 8. The second locking part 52 is positioned on an opposite side to the locking part 18 with the lever pin 8 interposed therebetween and is locked to the outer periphery 24 of the lever pin 8. The second locking part 52 extends in a corrugated shape along an extending direction of the second insertion part 50. In the fourth embodiment, the extending direction of the second insertion part 50 is the same direction (intersecting direction D3) as the extending direction of the insertion part 16. The second locking part 52 has an arc in the middle and is gently bent a plurality of times. The second locking part 52 is in contact with a portion of the outer periphery 24 of the lever pin 8 on the other side in the extending direction D2.

The second folded-back part 54 connects one end 50a of the second insertion part 50 on the one side in the intersecting direction D3 and one end 52a of the second locking part 52 on the one side in the intersecting direction D3. The second extending part 56 extends toward the joint part 7 with the other end 52b of the second locking part 52 on the other side in the intersecting direction D3 as a base point. A tip 57 of the second extending part 56 comes into contact with the upper surface 7a of the joint part 7. The connecting portion 58 connects the other end 50b of the second insertion part 50 on the other side in the intersecting direction D3 and the other end 16b of the insertion part 16 on the other side in the intersecting direction D3.

According to the fourth embodiment, the R-pin 14 presses the joint part 7 of the rod 10 against the lever plate 6 from both sides of the lever pin 8. Therefore, an effect of suppressing the shaking of the joint part 7 of the rod 10 in the plate thickness direction D1 can be increased.

The content described in each of the embodiments is understood, for example, as follows.
[1] A wastegate valve device (1) according to the present disclosure includes:
a valve body (2);
a lever shaft (4) that has one end side connected to the valve body;
a lever plate (6) that is provided on the other end side of the lever shaft,
a lever pin (8) that protrudes from the lever plate along a plate thickness direction (D1) of the lever plate;
a rod (10) that includes a plate-shaped joint part, in which an insertion hole (5) through which the lever pin is inserted is formed, on one end side thereof;
an actuator (12) for causing the rod to reciprocate; and
an R-pin (14) that is attached to the lever pin and that is positioned on an opposite side to the lever plate with the joint part interposed therebetween in the plate thickness direction,
in which the R-pin includes
   an insertion part (16) in which the lever pin is inserted through an extending hole (3) extending along a direction (D3) orthogonal to the plate thickness direction and that extends in a linear shape,
   a locking part (18) that is locked to an outer periphery (24) of the lever pin and that extends in a corrugated shape along an extending direction of the insertion part,
   a folded-back part (20) that connects one end (16a) of the insertion part on one side in the extending direction and one end (18a) of the locking part on the one side in the extending direction, and
   an extending part (22) that extends toward the joint part with the other end (18b) of the locking part on the other side in the extending direction as a base point and that has a tip (23) which comes into contact with one end surface (7a) of the joint part on an opposite side to a lever plate side.

With the configuration according to [1], as the R-pin includes the extending part, the R-pin can have a pressing function of pressing the joint part of the rod against the lever plate in addition to a retaining function from the related art for preventing the joint part of the rod from coming out of the lever pin. The pressing function eliminates a gap (clearance) between the joint part of the rod and the lever plate and suppresses shaking of the joint part of the rod in the plate thickness direction. For this reason, generation of noise or wear caused by collision between the joint part of the rod and the lever plate can be suppressed. In addition, since it is only necessary to include the extending part in the R-pin provided in the wastegate valve device from the related art instead of adding a member such as a leaf spring to the wastegate valve device, an increase in costs can be suppressed.

Further, with the configuration according to [1], as the R-pin has a pressing function, contact between the lever pin inserted through the insertion hole of the joint part and an inner peripheral surface of the insertion hole can be suppressed, and generation of noise or wear caused by collision between the joint part and the lever pin can also be suppressed.
[2] In some embodiments, in the configuration according to [1],
each of the locking part and the extending part is positioned on an opposite side to the one end side of the rod with respect to the insertion part.

When the joint part vibrates along the plate thickness direction, there is a case where a gap formed between the joint part and the lever plate increases from the lever pin toward the other end side (actuator side) of the rod. With the configuration according to [2], since the R-pin presses the joint part of the rod against the lever plate from the other end side of the rod with respect to the lever pin, the shaking of the joint part of the rod in the plate thickness direction can be further suppressed.
[3] In some embodiments, in the configuration according to [1] or [2],
the extending part includes a twisted portion (29) of which at least a part is twisted in an annular shape.

With the configuration according to [3], the R-pin increases a load that presses the joint part of the rod against the lever plate, and the shaking of the joint part of the rod in the plate thickness direction can be further suppressed.
[4] In some embodiments, in the configuration according to any one of [1] to [3],
the R-pin further includes a line contact portion (30) that extends from the tip of the extending part while being in contact with the one end surface of the joint part.

With the configuration according to [4], a load with which the R-pin presses the joint part of the rod against the lever plate acts widely on the one end surface of the joint part, and thus the shaking of the joint part of the rod in the plate thickness direction can be further suppressed. In addition, wear of at least one of the R-pin and the joint part of the rod caused by the load can be suppressed.
[5] In some embodiments, in the configuration according to [4],
the line contact portion includes
   a facing portion (40) that is positioned on an opposite side to the extending part with the lever pin interposed therebetween, and
   an extending connecting portion (42) that connects the facing portion and the extending part.

With the configuration according to [5], the R-pin presses the joint part of the rod against the lever plate from both sides of the lever pin. Therefore, an effect of suppressing the shaking of the joint part of the rod in the plate thickness direction can be increased.
[6] In some embodiments, in the configuration according to any one of [1] to [5],
the R-pin further includes
   a second insertion part (50) that is inserted through the extending hole and that extends in a linear shape,
   a second locking part (52) that is positioned on an opposite side to the locking part with the lever pin interposed therebetween to be locked to the outer periphery of the lever pin and that extends in a corrugated shape along a second extending direction of the second insertion part,
   a second folded-back part (54) that connects one end (50a) of the second insertion part on one side in the second extending direction and one end (52a) of the second locking part on the one side in the second extending direction,
   a second extending part (56) that extends toward the joint part with the other end (52b) of the second locking part on the other side in the second extending direction as a base point and that has a tip (57) which comes into contact with the one end surface of the joint part, and
   a connecting portion (58) that connects the other end (50b) of the second insertion part on the other side in the second extending direction and the other end (16b) of the insertion part on the other side in the extending direction.

With the configuration according to [6], the R-pin presses the joint part of the rod against the lever plate from both sides of the lever pin. Therefore, an effect of suppressing the shaking of the joint part of the rod in the plate thickness direction can be increased.
[7] A turbocharger (100) according to the present disclosure includes the wastegate valve device according to any one of [1] to [6].

With the configuration according to [7], it is possible to provide the turbocharger that can suppress generation of noise or wear caused by collision between the joint part of the rod and the lever plate.

### REFERENCE SIGNS LIST

1: wastegate valve device
2: valve body
3: extending hole
4: lever shaft
5: insertion hole
6: lever plate
6a: upper surface of lever plate
7: joint part
7a: upper surface of joint part
8: lever pin
10: rod
12: actuator
14: R-pin
16: insertion part
16a: one end of insertion part
18: locking part
18a: one end of locking part
18b: other end of locking part
20: folded-back part
22: extending part
23: tip of extending part
24: outer periphery of lever pin
25: tip surface
27: contact surface
29: twisted portion
30: line contact portion
40: facing portion
42: extending connecting portion
50: second insertion part
52: second locking part
54: second folded-back part
56: second extending part
57: tip of second extending part
58: connecting portion
100: turbocharger
102: turbine wheel
104: compressor wheel
106: rotating shaft
200: engine
202: exhaust gas line
204: intake line
206: upstream exhaust gas line
208: downstream exhaust gas line
210: bypass line
A: combustion air
D1: plate thickness direction
D2: extending direction
D3: intersecting direction
G: exhaust gas

1. A wastegate valve device comprising:
a valve body;
a lever shaft that has one end side connected to the valve body;
a lever plate that is provided on the other end side of the lever shaft;
a lever pin that protrudes from the lever plate along a plate thickness direction of the lever plate;
a rod that includes a plate-shaped joint part, in which an insertion hole through which the lever pin is inserted is formed, on one end side thereof;
an actuator for causing the rod to reciprocate; and
an R-pin that is attached to the lever pin and that is positioned on an opposite side to the lever plate with the joint part interposed therebetween in the plate thickness direction,
wherein the R-pin includes
an insertion part in which the lever pin is inserted through an extending hole extending along a direction orthogonal to the plate thickness direction and that extends in a linear shape,
a locking part that is locked to an outer periphery of the lever pin and that extends in a corrugated shape along an extending direction of the insertion part,
a folded-back part that connects one end of the insertion part on one side in the extending direction and one end of the locking part on the one side in the extending direction, and
an extending part that extends toward the joint part with the other end of the locking part on the other side in the extending direction as a base point and that has a tip which comes into contact with one end surface of the joint part on an opposite side to a lever plate side.

2. The wastegate valve device according to claim 1,
wherein each of the locking part and the extending part is positioned on an opposite side to the one end side of the rod with respect to the insertion part.

3. The wastegate valve device according to claim 1,
wherein the extending part includes a twisted portion of which at least a part is twisted in an annular shape.

4. The wastegate valve device according to claim 4,
wherein the R-pin further includes a line contact portion that extends from the tip of the extending part while being in contact with the one end surface of the joint part.

5. The wastegate valve device according to claim 4,
wherein the line contact portion includes
a facing portion that is positioned on an opposite side to the extending part with the lever pin interposed therebetween, and
an extending connecting portion that connects the facing portion and the extending part.

6. The wastegate valve device according to claim 1,
wherein the R-pin further includes
a second insertion part that is inserted through the extending hole and that extends in a linear shape,
a second locking part that is positioned on an opposite side to the locking part with the lever pin interposed therebetween to be locked to the outer periphery of the lever pin and that extends in a corrugated shape along a second extending direction of the second insertion part,
a second folded-back part that connects one end of the second insertion part on one side in the second extending direction and one end of the second locking part on the one side in the second extending direction,
a second extending part that extends toward the joint part with the other end of the second locking part on the other side in the second extending direction as a base point and that has a tip which comes into contact with the one end surface of the joint part, and
a connecting portion that connects the other end of the second insertion part on the other side in the second extending direction and the other end of the insertion part on the other side in the extending direction.

7. A turbocharger comprising the wastegate valve device according to claim 1.
